(19) United States
(12) Patent Application Publication
(10) Pub. No.: US 2004/0246485 A1
(43) Pub. Date: Dec. 9, 2004

(54) Far-field measurement of properties of metallic thin films

(76) Inventors: Behzad Imani, San Mateo, CA (US); Mark Luitzen Brongersma, Redwood City, CA (US)

Correspondence Address: MORRISON & FOERSTER LLP, 755 PAGE MILL RD, PALO ALTO, CA, 94304-1018, US

(21) Appl. No.: 10/616,482

(22) Filed: Jul. 8, 2003

Related U.S. Application Data
(60) Provisional application No. 60/477,275, filed on Jun. 9, 2003.

(51) Int. Cl. G01N 21/55

(52) U.S. Cl. 356/445

(57) ABSTRACT

Method and apparatus to optically measure properties of a metallic film using an excitation beam and a probe beam. The excitation beam creates a surface acoustic wave in the metallic film while the probe beam causes electron density waves (plasmons) in the metallic film. The detected intensity of the reflected probe beam indicates, e.g., a thickness of the metallic film.

### CROSS REFERENCE TO RELATED APPLICATION

This application claims priority to U.S. provisional application No. 60/477,275 filed Jun. 9, 2003.

### BACKGROUND OF THE INVENTION

This invention relates to thin films and optical measurement of properties of such thin films, for instance metallic thin films as used in the semiconductor industry for electrical interconnects on integrated circuits.

The known “ISTS” method (impulsive stimulated thermal scattering) uses a surface acoustic wave (SAW) generated in a film as a grating to diffract incident light on the film from a probe beam. Film properties such as thickness are determined from decay of the SAW over time. ISTS is best suited for films having a thickness greater than 100 nm.

### SUMMARY

We describe a far-field optical technique that can be used to determine the thickness of metallic thin films. It is based on the excitation of electron density waves known as surface plasmons. The detection in a far field experiment is done at least several optical wavelengths away from the object being observed. Without excitation of surface plasmons, the optical determination of the critical dimensions and thickness of metallic thin films and stripes is increasingly difficult and unreliable (such as ellipsometry) when the film thickness approaches the skin depth of the metal. In the optical and near-infra red optical region, typical skin depths for metal are on the order of 10 nm.

Advantageously, very thin films (1 to a few 100 nm thickness) can be probed using the present far-field technique, because it uses the excitation of the plasmons (electromagnetic waves coupled to electron density waves) that can travel along the interface between a dielectric and a conductor. Plasmons are generated by a light beam (the probing beam) impinging on a metal (the film.)

### BRIEF DESCRIPTION OF THE DRAWINGS

FIG. 1 is a diagram of a light wave incident on a grating.

FIG. 2 is a diagram of the optics of FIG. 1.

FIG. 3 is a measurement apparatus in accordance with FIGS. 1 and 2.

### DETAILED DESCRIPTION

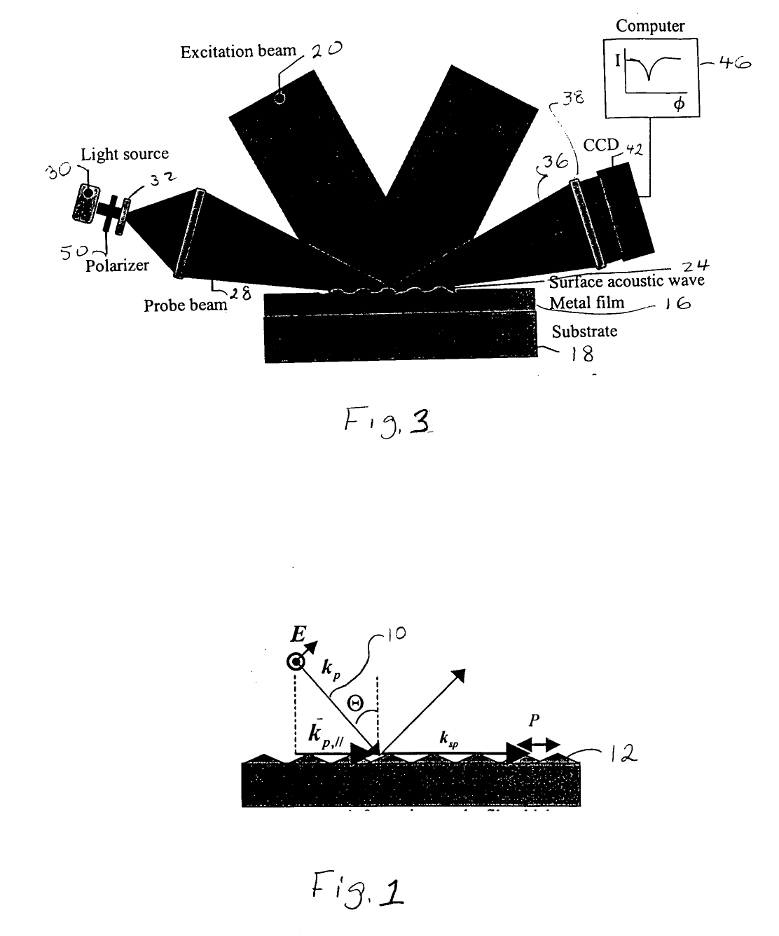

In order to obtain information on the film thickness or other properties, a surface plasmon needs to be excited at the interface between the metal and its substrate or other underlying dielectric. It is well established under which conditions such plasmons can be excited. One way is to create an interference grating on the metallic film surface. The excitation process is shown in FIG. 1, a diagram of a light wave incident on a metallic grating. On such a grating, a light wave with a wavevector kₚ can excite an electron density wave with a wavevector kₛₚ.

FIG. 1 shows in cross section a light beam 10 (the probing beam) incident on a metallic grating 12 with a period P. The light beam 10 has a TM polarization and has a wavevector kₚ. In order to couple energy from the incident light beam wave to the surface plasmon wave, the projection of kₚ onto the grating 12 surface k_{p,//}, needs to be equal to the wavevector of the surface plasmon kₛₚ, plus an integer number of times the reciprocal lattice vector G. G is determined by the period of the grating and its magnitude is: G=2π/P. The coupling condition is thus given by:

k_{//}=Kₛₚ±mG (I)

where m is an integer. This coupling condition can be understood from a plot of the dispersion relations for light and surface plasmons.

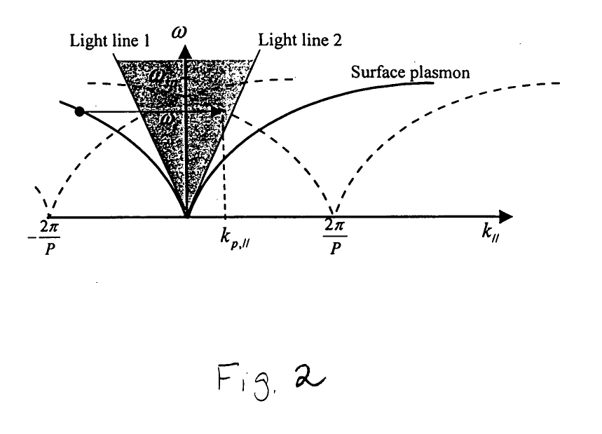

The lines labelled “Light linel” and “Light line 2” in related FIG. 2 show the dispersion relation for a light beam in air traveling to the left and to the right (known as the light line in air). By changing the angle of incidence of a light beam with a surface as in FIG. 1, one can excite plasmon waves with frequencies and wavevectors within the shaded area. The solid curves in FIG. 2 labeled “Surface plasmon” shows the dispersion relation for a surface plasmon traveling at the interface between a free electron metal and the substrate. Note that at every frequency ω the surface plasmon has a wavevector that is larger than the wave vector of the light beam in air. In other words, the solutions are outside the shaded area, implying that the surface plasmon waves cannot be excited using a laser (light) beam coming in from the air side. However, the grating 12 in FIG. 1 allows one to add an integer number m of reciprocal lattice vectors, G, to kₗₗ of the excitation light (equation I above). The solutions to equation I with m=1 and m=−1 are shown by the dashed lines in FIG. 2. It can be seen the dashed lines have solutions with k-vectors that are in between the two light lines (the shaded area). A grating 12 thus enables us to excite a surface plasmon wave from the far-field.

In the past, gratings have been patterned on metallic thin films to excite surface plasmons. In many applications it is undesired or impossible to pattern a grating on the metal film surface. We therefore exploit a surface acoustic wave (SAW) on a metal film surface as a non-permanent grating. Such a grating can be produced by interfering a relatively intense short pulsed laser beam onto the surface of the metal film. This interference pattern will cause a local heating and therefore expansion of the metal with a period that is determined by the period of the interference pattern. The local heating will build up a SAW with a small amplitude over the area of the excitation beam spot size on the metallic film surface.

The associated apparatus of FIG. 3 is implemented for measurement of metallic films using the above method. The sample (the metallic film 16 on a substrate 18) is placed on a support such as an X-Y-Z stage (not shown) for measurement. The spot size on the film 18 surface, where the measurement data is acquired, is illuminated by an excitation beam 20. The excitation beam 20 (from a conventional pulsed laser, not shown) produces a surface acoustic wave 24 that propagates on the metal film 16 surface, and a surface grating is thereby produced. At the same time the probing beam 28 (emanating from a light source 30 and focused by suitable lenses) can use the grating to excite a surface plasmon at the metal film/substrate interface 32. The resulting reflected light 36 is directed (via suitable lenses 38) towards a CCD camera 42 (detector) that records via computer 46 the angle dependent reflected light intensity. Every pixel within the detector 42 corresponds to a well-defined reflection angle. (The conventional mechanical supporting structures for the optical components are not shown in FIG. 3).

When the grating is induced by the excitation beam 20, the probing beam 28 excites a surface plasmon wave under a well-defined angle of incidence. It follows from the theory above (solving Maxwell's equations) that this “resonance” angle is critically dependent on the metal film 16 thickness. Coupling of energy from the probing beam 28 into the surface plasmon results in a reduced reflected intensity. A plot (as shown) in FIG. 3 of the reflected intensity of the probe beam as produced by computer 46 thus contains information of the thickness of the metal film 16. The CCD camera 42 will measure exactly such a plot and transmits the data to the computer 46 for further analysis if needed. Multiple spots on the metal film 16 surface can be measured sequentially for thickness using this method.

In one embodiment the probing beam 28 is polarized by a polarizer 50 (as shown in FIG. 3). Such use of polarization provides greater sensitivity.

Typical wavelengths for the probing and excitation beams are respectively 550 and 850 nm, but this is not limiting. Typical probing and excitation beam diameters (at the film 16 surface) are respectively 20 μm and 200 μm. The measured characteristic of the film 16 is, e.g., thickness, presence of voids, presence of defects, oxidation, etc.

This disclosure is illustrative and not limiting; further modifications will be apparent to one skilled in the art in light of this disclosure and are intended to fall within the scope of the appended claims.

What is claimed is:

1. A method of determining a characteristic of a conductive film, comprising the acts of:
providing a disturbance at a surface of the film;
directing a light beam onto the film so as to generate electron density waves in the film;
detecting an intensity of the light beam reflected from the film; and
determining the characteristic of the film from the detected intensity as a function of the reflectance angle.

2. The method of claim 1, wherein a thickness of the film is less than about 300 nm.

3. The method of claim 1, wherein a thickness of the film is less than about 100 nm.

4. The method of claim 1, wherein the film is of metal and a thickness of the film is about a skin depth of the metal.

5. The method of claim 1, wherein the disturbance is provided by directing a beam of energy onto the film.

6. The method of claim 1, wherein the disturbance as provided by directing a pulse of coherent light onto the film.

7. The method of claim 1, wherein the film comprises a metal.

8. The method of claim 5, wherein a diameter of the probe beam at the surface of the film is greater than the diameter of the excitation beam at the surface of the film.

9. The method of claim 1, wherein the act of determining comprises determining a resonance angle of the light beam associated with a change in the detected intensity of the light beam as a function of angle.

10. The method of claim 1, wherein the characteristic of the film is its thickness.

11. The method of claim 1, further comprising the act of:
polarizing the light beam prior to its reflection from the film.

12. The method of claim 1, wherein the disturbance is a surface acoustic wave.

13. The method of claim 1, wherein the disturbance is such as to allow the generation of the electron density waves by the light beam from a far-field.

14. Apparatus for determining a characteristic of a conductive film, comprising:
a support for the conductive film;
a source of energy arranged to direct the energy onto the film on the support, thereby to provide a disturbance in the film;
a source of a light beam arranged to direct the light beam onto the film to generate electron density waves in the film; and
a detector arranged to receive light from the light beam reflected from the film at different angles, thereby to determine the characteristic of the film from the reflected intensity of the light as a function of angle.

15. The apparatus of claim 14, wherein the source of energy and the source of the light beam are both lasers.

16. The apparatus of claim 14, further comprising a polarizer located to polarize the light beam.

17. The apparatus of claim 14, wherein the detector includes a CCD camera.
